(19) United States
(12) Patent Application Publication
(10) Pub. No.: US 2023/0149895 A1
(43) Pub. Date: May 18, 2023

(54) Curable Absorbent Films

(71) Applicant: Johnson & Johnson Consumer Inc., Skillman, NJ (US)

(72) Inventors: Lucas Taveira Caleiro, São José dos Campos (BR); Leonardo Caneppele, Jacarei (BR); Thiago Sidooski, São José dos Campos (BR); Maíra Martins de Souza Godoy Simões, São Paulo (BR)

(21) Appl. No.: 18/052,707

(22) Filed: Nov. 4, 2022

Related U.S. Application Data
(60) Provisional application No. 63/264,177, filed on Nov. 17, 2021.

(51) Int. Cl. B01J 20/26; B01J 20/28; B01J 20/30

(52) U.S. Cl. CPC B01J 20/261; B01J 20/28033; B01J 20/3085

(57) ABSTRACT

The present invention relates to curable compositions useful in the manufacture of absorbent films or absorbent film products. Methods of using and manufacturing the compositions also disclosed.

### CROSS REFERENCE TO RELATED APPLICATIONS

This application claims the benefit of U.S. provisional application 63/264,177 filed on Nov. 17, 2021, the complete disclosure of which is hereby incorporated herein by reference for all purposes.

### TECHNICAL FIELD

The present invention relates to curable compositions useful in the manufacture of absorbent films or absorbent film products. Methods of using and manufacturing the compositions are also disclosed.

### BACKGROUND OF THE INVENTION

Absorbent articles are well known and commonly used in personal care absorbent products such as diapers, training pants, sanitary napkins, incontinence garments, bandages and the like.

In certain absorbent articles, the absorbent article (or specific layers or substrates of the article) contain absorbency materials such as superabsorbent polymers (SAP) to improve the articles' absorbency.

Layers of such SAP containing substrates or layers may also be prepared. Common techniques (such as coating, spinning, spraying or 3D printing), however, often involve polymerizing hydrophilic monomers in solvents such as water. When films are prepared in this way, require thermal reaction and/or drying, or removal of water (or other solvent), prior to use. Accordingly, such techniques are unsuitable for producing SAP containing film substrates or layers as part of a continuous manufacturing process.

Accordingly, there is a need for improved pourable or sprayable SAP containing film composition which can be rapidly cured to improve manufacturing efficiency.

The present inventors have discovered that absorbent, structured film materials can be prepared from select liquid or semi-solid precursor formulations which can be rapidly cured using UV radiation. The liquid or semi-solid precursor formulations further exhibit such outstanding characteristics as high processability, which enables its customization into products with different colors, sizes, shapes, and favorable mechanical properties for skin/body application, and good fluid absorption capacity.

### DESCRIPTION OF FIGURES

FIG. 1 illustrates the chemical structure of a preferred embodiment of the absorbent film of the present invention.

FIG. 2 is a graph showing force versus elongation measurements of a polyester, single layer nonwoven material and a single layer embodiment of the absorbent film of the present invention as prepared in accordance with Example 1.

FIG. 3 is a graph comparing the average water absorption capacity of two commercial single layer absorbent films versus an embodiment of the absorbent film of the present invention as prepared in accordance with Example 1.

### SUMMARY OF THE INVENTION

The compositions of the present invention relate to compositions for preparing radiation curable substrates, the composition before curing comprising:

(i) An acrylate monomer having the formula:

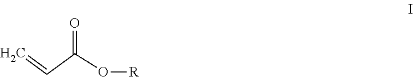

wherein R is a hydrogen; an inorganic charged ion; a linear, branched or aromatic alkyl group having a carbon chain length of less than 30 carbons, the alkyl group comprising one or more single, double or triple carbon bond(s); an acrylate group selected from acrylates (mono), di-acrylates, tri-acrylates, tetra-acrylate, pent-acrylate and hex-acrylates;

(ii) An acrylate oligomer having the formula:

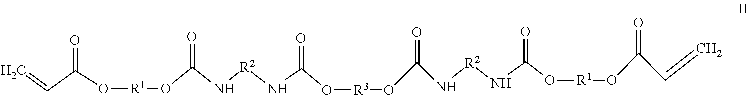

wherein R¹, R² or R³ are, independently, aromatic or aliphatic organic groups having a carbon chain length of less than 50 carbons, the alkyl group comprising one or more single, double or triple carbon bond on its structure; an acrylate group selected from acrylates (mono), di-acrylates, tri-acrylates, pent-acrylates, hex-acrylates; a C₁-C₃ organic functional group selected from acids, alcohols, ethers, esters, ketones, thiols, amines, aldehydes and amides; a hydrogen atom or an inorganic charged ion;

(iii) one or more absorbing polymers;

(iv) a photo initiator; and

(v) a solvent.

The present invention also relates to methods of making and using the above described curable compositions.

### DETAILED DESCRIPTION OF THE INVENTION

The compositions of the present invention can comprise, consist of, or consist essentially of the essential elements and limitations of the invention described herein, as well any of the additional or optional features, components, or limitations described herein.

The term “comprising” (and its grammatical variations) as used herein is used in the inclusive sense of (and, interchangeably with the terms) “having” or “including” and not in the exclusive sense of “consisting only of.”

The terms “a” and “the” as used herein are understood to encompass the plural as well as the singular. Also, as used herein, “a,” “an,” “the,” “at least one,” and “one or more” are used interchangeably. Thus, for example, a composition that comprises “an” element can be interpreted to mean that the composition includes “one or more” such elements.

All documents incorporated herein by reference in their entirety are only so incorporated to the extent that the disclosure therein is not inconsistent with this specification.

As used herein, the term “alkyl,” when used alone or as part of a larger moiety (e.g., as in “cycloalkenylalkyl” or “haloalkyloxy”), refers to a saturated aliphatic hydrocarbon group. It can contain at least (e.g., 1 to 2, 1 to 3, or 1 to 4) carbon atoms. As a moiety, it can be denoted as —CₙH₂ₙ₊₁. An alkyl group can be linear or branched. Examples of alkyl groups include, but are not limited to, methyl, ethyl, propyl, isopropyl, butyl, isobutyl, sec-butyl, tert-butyl, n-pentyl, n-heptyl, and 2-ethylhexyl. An alkyl group can be substituted (i.e., optionally substituted) with one or more substituents. When an alkyl is preceded by a carbon-number modifier, e.g., C₁₋₈, it means the alkyl group contains 1 to 8 carbon atoms.

As used herein, the term “derivative” (or “analog’) refers a compound that is derived from a compound that is not similar in chemical or physical process. For instance, if one atom in an initial compound is replaced with another atom or group of atoms, the resultant compound is considered as a derivative or analog of the initial compound.

As used herein, “pharmaceutically acceptable,” “cosmetically acceptable,” or “dermatologically acceptable” means suitable for use in contact with tissues (e.g., the skin (including scalp), hair, mucosa, epithelium or the like) without undue toxicity, incompatibility, instability, minimizing irritation, or allergic response.

As used herein, “safe and effective amount” means an amount sufficient to provide a desired effect at a desired level, but low enough to avoid serious side effects.

As used herein, the term inorganic charged ion can encompass anionic or cationic ions and includes, but is not limited to, alkali metals, alkaline-earth metals and halogens. In certain embodiments, the inorganic charged ion is an alkali metal or alkaline-earth metal. In certain embodiments, the inorganic charged ion is selected from singly charged positive ions such as Na, and K. In certain embodiments, the inorganic charged ion is selected from doubly charged positive ions such as Ca, Mg, Zn and Cu.

As used herein, the terms “independent” or “independently”, when referring to optional substituent “R” groups (e.g., R¹, R², R³ etc.,) means that the number of “R” substituents is more than one (e.g., two or three) and that these multiple “R” substituents can be the same or different.

As used herein, the term “structure” or “structured” as used when referring to the absorbent film of the present invention means sufficient mechanical resistance to bend and elongate at forces lower than 5 kgf and not to break, including a high degree of flexibility—at least 30% elongation at forces lower 0.30 kgf.

As used herein, the term “20/20 vision” as used when describing visual observations means the ability to see what an average individual can see on a standard eye (vision) testing chart at a distance of 20 feet from such chart.

In certain embodiments, the present invention as disclosed herein may be practiced in the absence of any ingredient, component, element (or group of components or elements) or method step which is not specifically disclosed herein.

### Precursor Materials:

### Acrylate Monomer:

The compositions of the present invention, prior to or after any curing process (e.g., UV curing), comprise one or more acrylate monomers having the formula:

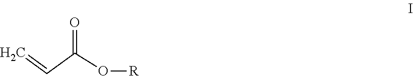

wherein R is a hydrogen; an inorganic charged ion; a linear, branched or aromatic alkyl group having a carbon chain length of less than 30 carbons, optionally, from 5 to 20 carbons, optionally, from 5 to 15 carbons, optionally, from 6 to 13 carbons, optionally, from 6 to 9 carbons, the alkyl group comprising one or more single, double or triple carbon bond(s); an acrylate group capable of interacting with one of more other acrylate sites (or functional groups), including, but not limited to, (or selected from) acrylates (mono), di-acrylates, tri-acrylates, tetra-acrylate, pent-acrylate, hex-acrylates etc.

Acrylate monomers suitable for use in the compositions of the present invention include, but are not limited to, (or selected from) acrylates (mono) such as 2-[[(butylamino)carbonyl]oxy]ethyl acrylate (Photomer 4184, supplied by IGM Resins), 2-hydroxyethyl acrylate, 2-(2-ethoxyethoxy) ethyl acrylate, lauryl acrylate, 2-hydroxyethyl methacrylate, ethyl acrylate, propyl acrylate, butyl acrylate, acrylic acid, 2-ethylhexyl acrylate; di-acrylates such as tripropyleneglycol diacrylate (TPGDA) (Photomer 4061, supplied by Quiminutri), neopentylglycol [2PO] diacrylate (NPGPODA), Bisphenol-A 4EO diacrylate, polyethylene glycol diacrylate (PEG200DA/PEG400DA/PEG600DA); tri-acrylates such as trimethylolpropane triacrylate glyceryl triacrylate; tetra-acrylates such as ditrimethylolpropane tetra-acrylate; hex-acrylates such as dipentaerythritol hexaacrylate; variations of these compounds and mixtures thereof. Preferably, the acrylate monomer comprises one or more of acrylates (mono) and di-acrylates. Acrylates preferred for use in the compositions of the present invention are selected from (selected from the group consisting of) 2-[[(butylamino)carbonyl]oxy]ethyl acrylate (Photomer 4184, supplied by IGM Resins), di-acrylates such as tripropyleneglycol diacrylate (TPGDA) (Photomer 4061, supplied by Quiminutri) and mixtures thereof.

In certain embodiments, the acrylate monomer is present in the compositions of the present invention at concentrations of from about 12% to about 37%, optionally, from about 18% to about 24%, by weight of the total composition.

In certain embodiments, the absorbent films of the present invention contain less than about 90%, optionally, less than about 70% and optionally, less than about 50% of low molecular weight acrylate monomers having an weight average molecular weight of from about 160 to about 700, optionally, from about 180 to about 600, and optionally, from about 220 to about 400 daltons. Without being limited by theory, it is believed that the lower the quantity of low molecular weight acrylate monomers used, the lower the brittleness of inventive film.

### Acrylate Oligomer Compound:

The compositions of the present invention, prior to or after any curing process (e.g., UV curing), comprise one or more acrylate oligomer compounds having the formula:

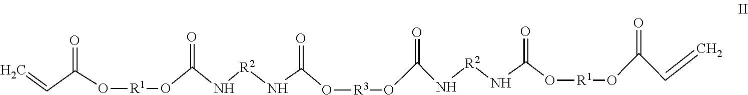

wherein R¹, R² or R³ are, independently, aromatic or aliphatic organic groups having a carbon chain length of less than 50 carbons, optionally, from 5 to 25 carbons, the alkyl group comprising one or more single, double or triple carbon bond on its structure; an acrylate group capable of interacting with one or more other acrylate sites (or functional groups), including, but not limited to, (or selected from) acrylates (mono), di-acrylates, tri-acrylates, pent-acrylates, hex-acrylates etc, preferred for use herein are di-acrylates; a C₁-C₃ organic functional group such as, like but not limited, (selected from) acids, alcohols, ethers, esters, ketones, thiols, amines, aldehydes and amides; a hydrogen or an inorganic charged ion.

The acrylate oligomer has one or more polymerizable unsaturated groups such as acrylate, methacrylate or polyesteracrylate substituents. Suitable acrylate oligomer includes, but are not limited to, aliphatic urethane acrylate (which can comprise mono, di-, tri-, tetra-, penta- or hex-acrylate), aromatic urethane acrylate (which can comprise mono, di-, tri-, tetra-, penta- or hex-acrylate), polyester acrylate (which can comprise mono, di-, tri-, tetra-, penta- or hex-acrylate), fatty acid, modified polyester acrylate (which can comprise mono-, di-, tri-, tetra-, penta- or hex-acrylate), and mixtures thereof.

In certain the embodiments, the following may be used as the acrylate oligomer Photomer 6643/GU3001Z (aliphatic urethane diacrylate), GU3300W, Photomer 6720/GU6600Y (aromatic urethane hexaacrylate), GU7200Z, GU4280B, GU9900Y, each, by QUALIPOLY Co., Ltd., EBCRYL 8411, EBCRYL 8413, EBCRYL 230 by ALLNEX Co., Ltd. Mixtures of any of the above acrylate oligomers may also be used. The above QUALIPOLY Co., Ltd. and ALLNEX Co., Ltd. acrylate oligomers are described in more detail below:

QUALIPOLY Co., Ltd. acrylate oligomers:

| | | | Color | | | | | | | | |
|---|---|---|---|---|---|---|---|---|---|---|---|
| Product | Chemical | Function- | (Gardner) | Mol. | T_{g} | Viscosity | Reac- | Flexi- | Chemical | Abrasion | Acid value |
| Name | Composition | ality | (max.) | Weight | (° C.) | (25° C., cps) | tivity | bility | Resistance | Resistance | Mg KOH/g |
| GU6600Y | Aromatic Urethane | 6 | 2 | 950 | 49 | 24,500-32,500 | 5 | 1 | 5 | 4 | — |
| | Hexaacrylate | | | | | | | | | | |
| GU3001Z | Aliphatic Urethane | 2 | 2 | 5500 | −40 | 35,000-65,000 | 1 | 5 | 3 | 4 | — |
| | Diacrylate | | | | | (60° C.) | | | | | |
| GU4280B | Aliphatic Urethane | 4 | 100 | 1600 | N/A | 20,000-40,000 | 5 | 2 | 4 | 3 | — |
| | Triacrylate | | (APHA) | | | | | | | | |
| GU3300W | Aliphatic Urethane | 2 | 2 | 1500 | −27 | 55,000-75,000 | 2 | 5 | 3 | 3 | — |
| | Diacrylate | | | | | | | | | | |
| GU7200Z | Aliphatic Urethane | 9 | 2 | 1450 | 102 | 10,000-22,000 | 5 | 1 | 3 | 5 | — |
| | Multi-acrylate | | | | | (60° C.) | | | | | |
| GU9900Y | Fatty Acid Modified | 6 | 5 | 1500 | 17 | 7,000-12,000 | 25 | 5 | 4 | 4 | 1 |
| | Polyester hexaacrylate | | | | | | | | | | |

ALLNEX Co., Ltd. acrylate oligomers:

| | | Typical Properties | | | | | | | | |
|---|---|---|---|---|---|---|---|---|---|---|
| | | | | | Color, | | | | | |
| | | | | | Gardner | Acid | Tensile | Tensile | | Density, |
| | Description | Function- | | Viscosity, | (Pt—Co), | Value, | Strength, | Elongation, | T_{g}, | g/ml at |
| Product | Key Features & Performance | ality | Diluent | cP | [Iodine] | mg KOH/g | psi | % | ° C. | 25° C. |
| EBECRYL | Aliphatic Urethane Diacrylate | 2 | IBOA | 149500 | 0.3 | — | 1170 | 320 | −18 | 1.13 |
| 8411 | Outstanding extensibility | | 20% | (25° C.) | | | | | | |
| | and flexibility | | | 7779 | | | | | | |
| | Useful in screen inks | | | (60° C.) | | | | | | |
| | Good abrasion resistance | | | | | | | | | |
| | Good exterior durability | | | | | | | | | |
| EBECRYL | Aliphatic Urethane Diacrylate | 2 | IBOA - | 32800 | — | — | 2200 | 550 | — | 1.04 |
| 8413 | Excellent extensibility, | | 33% | (60° C.) | | | | | | |
| | 550% elongation at break | | | | | | | | | |
| | Good milling properties | | | | | | | | | |
| | Well suited for | | | | | | | | | |
| | thermoformable coatings | | | | | | | | | |
| | and inks | | | | | | | | | |
| | Low shrinkage | | | | | | | | | |
| | Good adhesion | | | | | | | | | |
| EBECRYL | Aliphatic Urethane Diacrylate | 2 | — | 44014 | (16) | — | 150 | 83 | −55 | 1.08 |
| 230 | High molecular weight | | | (25° C.) | | | | | | |
| | Soft | | | 3.150 | | | | | | |
| | Very flexible | | | (60° C.) | | | | | | |
| | Low T_{g} | | | | | | | | | |

Acrylate oligomers preferred for use the compositions of the present invention are selected from (selected from the group consisting of) Photomer 6643/GU3001Z (aliphatic urethane diacrylate), Photomer 6720/GU6600Y (aromatic urethane hexaacrylate) and mixtures thereof.

Without being limited by theory, it is believed that the higher the functionality (or reactivity) of the acrylate oligomers, the higher the cross-linking in the inventive film. Higher functionality is achieved by incorporating, as functional groups, acrylates of increasing or higher degrees of acrylations. For example, acrylates (mono) have lower acrylation (and are less reactive) than di-acrylates which have lower acrylation (and are less reactive) than tri-acrylates which have lower acrylation (and are less reactive) than tetra-acrylates which have lower acrylation (and are less reactive) than penta-acrylates as so forth. In certain embodiments, however, having too high reactivity can lead to increased brittleness and very poor water absorption), accordingly, in certain embodiments, acrylate oligomers comprise acrylate functional groups of differing acrylation. In certain embodiments, acrylate (mono) functional groups are incorporated with one or more di-, tri-, tetra-, penta- or hex-acrylate functional groups at a ratio of (mono)acrylate to one or more di-, tri-, tetra-, penta- or hex-acrylate(s) of from about 50:50 to about 70:30, optionally, from about 90:10 to about 97:3 on a weight basis.

By modifying the above molecular weight of the acrylate monomer component and functionality of the acrylate oligomer component, it is possible to achieve films having the appropriate mechanical behavior for the desired applications (e.g. films with more or less elasticity, flexibility, rupture strength, etc.).

The acrylate oligomer is present in the compositions of the present invention at concentrations of from about 30% to about 70%, optionally, from about 40% to about 50% by weight of the total composition.

### Absorbent Polymers

The compositions of the present invention, prior to and after any curing process (e.g., UV curing), comprise one or more absorbent (or absorbing) or super absorbent (or super absorbing) polymers.

Absorbent or super-absorbent polymers are water-swellable, water-insoluble organic or inorganic materials capable of absorbing at least about 10 times their own weight of an aqueous solution containing 0.9 weight percent of sodium chloride. Organic materials suitable for use as absorbent or super-absorbent materials can include, but are limited to, natural materials such as polysaccharides, polypeptides and the like, as well as synthetic materials such as synthetic hydrogel polymers. Such hydrogel polymers include, for example, alkali metal salts of polyacrylic acids, polyacrylamides, polyvinyl alcohol, polyacrylates, polyacrylamides, polyvinyl pyridines, and the like and mixtures thereof. Other suitable polymers include hydrolyzed acrylonitrile grafted starch, acrylic acid grafted starch, and isobutylene maleic anhydride copolymers and mixtures thereof. The hydrogel polymers are, in certain embodiments, lightly cross-linked to render the material substantially water insoluble. In certain embodiments, the absorbent or super-absorbent polymer materials are further surface cross-linked so that the outer surface or shell of the super-absorbent polymer particle, fibre, flake, sphere, etc. possesses a higher crosslink density than the inner portion of the super-absorbent. In other embodiments, multiple thin films could be layered to produce a thick film such that thick film exhibits the properties and behavior detailed above where the cross-linking density between the outer most film and the next inner adjacent film of the composite (or thick) film is less the cross-linking density between any of the other more inner films.

Suitable super-absorbent polymers can also be found in U.S. Pat. No. 7,026,373 B2, herein incorporated by reference in its entirety.

In certain embodiments, cellulosic absorbent materials such as cellulose, carboxymethyl cellulose, carboxyethyl cellulose, and hydroxypropyl cellulose mixtures may be used in addition to, or in place of, the super absorbent polymers.

Mixtures of the above described absorbent or super-absorbent polymers may be used.

The absorbent or super absorbent polymers are present in the compositions of the present invention at concentrations of from about 0.1% to about 10%, optionally, from about 1% to about 4% by weight of the total composition.

### Photo-Initiators

The compositions of the present invention, prior to or after any curing process (e.g., UV curing), comprise one or more photo-initiators.

Photo-initiators can respond rapidly and efficiently to a light source with the production of radicals, cations, and other species that are capable of initiating a polymerization reaction. The photo-initiators used in the present invention may absorb UV and visible light at wavelengths of about 200 nanometers (nm) to about 800 nm, in certain embodiments about 200 nm to about 400 nm.

There are two types of photo initiators. Type I photo initiators are molecules which are cleaved when exposed to UV radiation, forming two free radicals that start the chemical reaction responsible for the crosslink and polymerization reaction. Type II photo initiators are molecules that pass into a higher excited state upon UV light exposition. In certain embodiments, the type II photo initiator is combined with an additional component called a co-initiator to improve its effectiveness.

In certain embodiments, the compositions of the present invention can include type I photo-initiators. Examples of useful type I photo-initiators include (or are selected from) benzyl ketals, a-hydroxyalkyl phenones, a-amino alkyl phenones, and acylphospine oxides—such as Omnirad TPO-L (ethyl (2,4,6-trimethylbenzoyl)-phenylphosphinate, supplied by IGM) and/or 2-hydroxy-2-methyl-1-phenylpropan-1-one and mixtures thereof.

In certain embodiments, these photo-initiators are incorporated in combination as in the case of the 50:50 blend sold by Ciba Specialty Chemicals, Ludwigshafen, Germany as DAROCUR® 4265).

In certain embodiments, the preferred photo-initiator is Omnirad TPO-L (ethyl (2,4,6-trimethylbenzoyl)-phenylphosphinate, supplied by IGM)

In certain embodiments, the compositions of the present invention comprise type II photo-initiators in amounts suitable to initiate intended reactions. Type II photo-initiators useful herein include, but are not limited to, (or selected from) benzophenone, thioxanthone, isopropyl thioxanthone and camphorquinone and mixtures thereof.

More specific examples of type I and type II photo-initiators include, but are not limited to, hydroxyacetophenone (HAP), benzyl dimethyl ketal (available under tradename as IRGACURE 651); α-,α-dimethoxy-a-hydroxy acetophenone (available under tradename DAROCUR® 1173); 2-methyl-1-[4-(methyl thio) phenyl]-2-morpholino-propan-1-one (available under tradename IRGACURE® 907); 1-hydroxycyclohexyl-phenyl ketone (available under tradename IRGACURE® 184); bis(2,4,6-trimethylbenzoyl)-phenylphosphineoxide (available under tradename IRGACURE 819); diethoxyacetopbhenone, and 4-(2-hydroxyethoxy)phenyl-(2-hydroxy-2-methylpropyl) ketone (available under tradename IRGACURE® 2959); and Oligo [2-hydroxy-2-methyl-1-[4-(1-methylvinyl) phenyl]propanone] (available under tradename ESACURE® KIP EM). Mixtures of these photo-initiators may also be used.

Suitable co-initiators include, but are not limited to, (or selected from) amines, polymeric amine synergists and thiols such as Ebecryl LED 03® (Amine modified polyether acrylate supplied by Allnex), Ebecryl LED 02® (Polyol acrylate mixture with mercapto derivate supplied by Allnex), Esacure A198® (mixture of benzoic acid, 4-(dimethylamino), 1,1′-[(methylamino)di-2,1-ethanediyl]ester supplied by IGM), and mixtures thereof. The most preferred co-initiator is Ebecryl LED 02 (Polyol acrylate mixture with mercapto derivate supplied by Allnex). In certain embodiments, the compositions of the present invention comprise a synergist, such as polymeric amine synergists in amounts suitable to increase reaction output. Examples of suitable such synergists include, but not limited to, derivatives of aniline and a polyether amine such as Jeffamine® 900 and mixtures thereof. In certain embodiments, the amine synergist can be trimethylamine, triethanolamine, methyldiethanolamine, phenyldiethanolamine, N,N,N′,N′-tetra(hydroxylethyl)ethylenediamine, dimethylaminoethyl acrylate, dimethylaminoethyl methacrylate, ethyl dimethylaminobenzoate, or mixtures thereof.

Other suitable photo-initiators are detailed in US Patent Publication US20190284417, incorporated herein by reference in its entirety.

Mixtures of any of the above described photo-initiators, co-initiators and synergists may also be used.

The photo-initiators (either type I and/or type II) are present in the compositions of the present invention at concentrations of from about 0.1% to about 8%, optionally, from about 2% to about 4% by weight of the total composition.

### Solvents

In certain embodiments, the compositions of the present invention, prior or after any curing process (e.g., UV curing), comprise one or more solvents. Suitable examples include but not limited to, (or selected from or selected from the group consisting of) organic solvents such as acetonitrile, methanol, and ethanol, propanol, etc.; reactive solvent such as acrylate monomers with low molecular weight; or inorganic solvents (e.g., water, saline in water mixture solvents, acid in water mixture solvents, basic [>than pH 9] water solvents, etc.) and mixtures thereof. In certain embodiments, the solvent is or comprises water.

In certain embodiment, the solvent is present in the compositions of the present invention at concentrations of from about 5% to about 50%, optionally, from about 15% to about 30% by weight of the total composition.

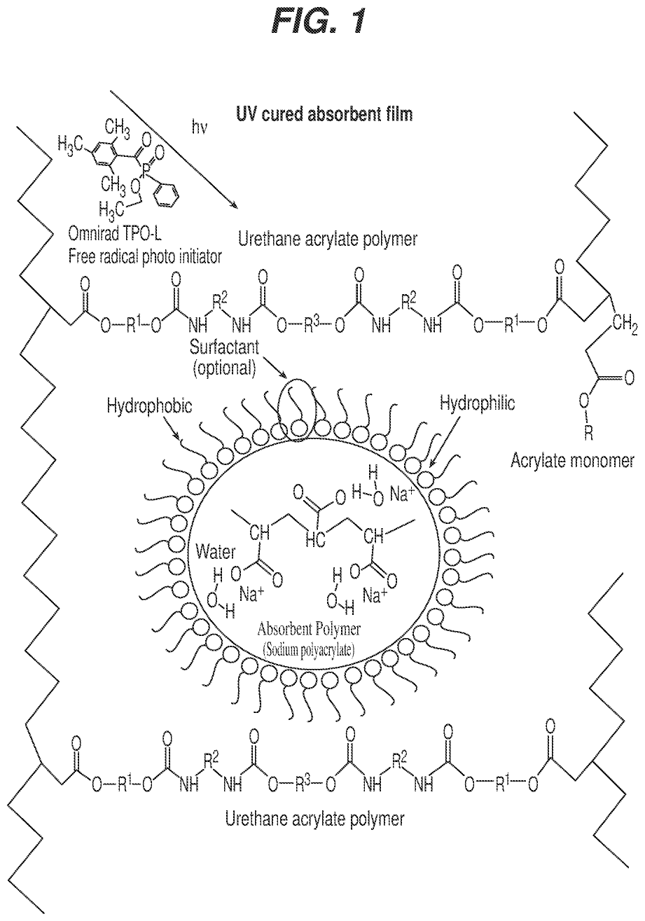

The chemical structure of the cured film is a cross-linked structure of the acrylate oligomers and acrylate monomers with super absorbent polymer hydrophilic gel dispersed within the cross-linked structure. During the curing process, cleavage of the double bonds present in the acrylate monomers and oligomers takes place, facilitating further cross-linking and increased cross-linking density. The cured film structure formed from the formulation of table 1 is illustrated in FIG. 1.

In certain embodiments, the compositions are cured using heat, radiation, electron beams, or chemical additives. Preferably, the compositions of the present invention are cured using UV radiation or light.

Curing of the compositions of the present invention by UV radiation or light generally takes from between about 10 to about 0.5 seconds, preferably from about 5 to about 1 second or preferably is instantaneous with the application of UV radiation or light to the composition of the present invention.

FIG. 1 shows that once cured, the reactive ingredients of the film formulation (i.e., the oligomers, monomers and photo initiator) forms a micellar structure with the hydrated super absorbent polymer plus components. Optionally, surfactants may be added to aid in the creation micellar structures which, in turn, may facilitate the interaction between the hydrophilic part (comprising hydrated super absorbent polymer) and the hydrophobic part (structure comprising acrylate monomer and acrylate oligomer reactive ingredients). Vigorous agitation helps ensure mixing of these hydrophobic and hydrophilic portions.

Without being limited by theory, it is believed that once the film is cured, the gel component forms micro channels on the polymeric structure of the film. When the cured film is exposed to water, there is an osmotic pressure resultant from the difference between the ion concentration inside and outside the polymer structure. The ion concentration inside polymer structure is much higher than outside due the presence of superabsorbent polymers like the sodium acrylate showed on FIG. 1. In order to achieve an equilibrium state, the water starts to flow to the inner polymer structure due the presence of channels that were formed by the high agitation and subsequent cure. The film starts to absorb water and to swell until the ion concentration achieve the equilibrium or the force made by the SAP swelling be in equilibrium with the mechanical resistance of the film structure deformation.

By the absorption mechanism explained above, the absorption capacity can be controlled changing different properties of the film material like the ion concentration inside the polymeric structure, the channels formation, the deformation resistance of polymeric structure, etc.

### Optional Ingredients:

### Surfactants

Any of a variety of additional surfactants may be used in the present invention. Suitable surfactants may include anionic, non-ionic, cationic, amphoteric, zwitterionic surfactants, and combinations of two or more thereof. Examples of suitable surfactants are disclosed, for example, in U.S. Pat. No. 7,417,020 to Fevola, et al which is incorporated in its entirety herein by reference.

In certain embodiments, the compositions of the present invention comprise a non-ionic surfactant. Those of skill in the art will recognize that any of a variety of one or more non-ionic surfactants include, but are not limited to, compounds produced by the condensation of alkylene oxide groups (hydrophilic in nature) with an organic hydrophobic compound which may be aliphatic or alkyl-aromatic in nature. Examples of suitable nonionic surfactants include, but are not limited to, alkyl polyglucosides; alkyl glucose amines, block copolymers such as ethylene oxide and propylene oxide copolymers e.g. Poloxamers; ethoxylated hydrogenated castor oils available commercially for example under the trade name CRODURET (Croda Inc., Edison, N.J.); alkyl polyethylene oxide e.g. Polysorbates, and/or; fatty alcohol ethoxylates; polyethylene oxide condensates of alkyl phenols; products derived from the condensation of ethylene oxide with the reaction product of propylene oxide and ethylene diamine; ethylene oxide condensates of aliphatic alcohols; long chain tertiary amine oxides; long chain tertiary phosphine oxides; long chain dialkyl sulfoxides; and mixtures thereof.

Exemplary non-ionic surfactants are selected from the group known as poly(oxyethylene)-poly(oxypropylene) block copolymers. Such copolymers are known commercially as poloxamers and are produced in a wide range of structures and molecular weights with varying contents of ethylene oxide. These non-ionic poloxamers are non-toxic and acceptable as direct food additives. They are stable and readily dispersible in aqueous systems and are compatible with a wide variety of formulations and other ingredients for oral preparations. These surfactants should have an HLB (Hydrophilic-Lipophilic Balance) of between about 10 and about 30 and preferably between about 10 and about 25. By way of example, non-ionic surfactants useful in this invention include the poloxamers identified as poloxamers 105, 108, 124, 184, 185, 188, 215, 217, 234, 235, 237, 238, 284, 288, 333, 334, 335, 338, 407, and combinations of two or more thereof. In certain preferred embodiments, the composition comprises poloxamer 407.

In certain embodiments, the compositions of the claimed invention comprise non-ionic surfactants at from about 0.05% to about 2%, optionally, from about 0.2 to about 0.8%, by weight of the total composition.

In certain embodiments, the compositions of the present invention also contain at least one alkyl sulfate surfactant. In certain embodiments, suitable alkyl sulfate surfactants include, but are not limited to sulfated C₈ to C₁₈, optionally sulfated C₁₀ to C₁₆ even numbered carbon chain length alcohols neutralized with a suitable basic salt such as sodium carbonate or sodium hydroxide and mixtures thereof such that the alkyl sulfate surfactant has an even numbered C₈ to C₁₈, optionally C₁₀ to C₁₆, chain length. In certain embodiments, the alkyl sulfate is selected from the group consisting of sodium lauryl sulfate, hexadecyl sulfate and mixtures thereof. In certain embodiments, commercially available mixtures of alkyl sulfates are used.

In certain embodiments, the alkyl sulfate surfactant is present in the compositions of the present invention at from about 0.05% to about 2%, optionally, from about 0.2 to about 0.8%, by weight of the total composition.

Another suitable surfactant is one selected from the group consisting of sarcosinate surfactants, isethionate surfactants and taurate surfactants. In certain embodiments, alkali metal or ammonium salts of these surfactants, such as the sodium and potassium salts of the following: lauroyl sarcosinate, myristoyl sarcosinate, palmitoyl sarcosinate, stearoyl sarcosinate and oleoyl sarcosinate are used herein. The sarcosinate surfactant may be present in the compositions of the present invention at from about 0.05% to about 2%, optionally, from about 0.2 to about 0.8%, by weight of the total composition.

Zwitterionic synthetic surfactants useful in the present invention include derivatives of aliphatic quaternary ammonium, phosphonium, and sulfonium compounds, in which the aliphatic radicals can be straight chain or branched, and wherein one of the aliphatic substituents contains from about 8 to 18 carbon atoms and one contains an anionic water-solubilizing group, e.g., carboxy, sulfonate, sulfate, phosphate or phosphonate.

The amphoteric surfactants useful in the present invention include, but are not limited to, derivatives of aliphatic secondary and tertiary amines in which the aliphatic radical can be a straight chain or branched and wherein one of the aliphatic substituents contains from about 8 to about 18 carbon atoms and one contains an anionic water-solubilizing group, e.g., carboxylate, sulfonate, sulfate, phosphate, or phosphonate. Examples of suitable amphoteric surfactants include, but are not limited alkylimino-diproprionates, alky lamphoglycinates (mono or di), alkylamphoproprionates (mono or di), alkylamphoacetates (mono or di), N-alkyl [3-aminoproprionic acids, alkylpolyamino carboxylates, phosphorylated imidazolines, alkyl betaines, alkylamido betaines, alkylamidopropyl betaines, alkyl sultaines, alkylamido sultaines, and mixtures thereof. In certain embodiments, the amphoteric surfactant is selected from the group consisting of alkylamidopropyl betaines, amphoacetates such as sodium auroamphoacetate and mixtures thereof. Mixtures of any of the above-mentioned surfactants can also be employed. A more detailed discussion of anionic, nonionic and amphoteric surfactants can be found in U.S. Pat. No. 7,087,650 to Lennon; U.S. Pat. No. 7,084,104 to Martin et al.; U.S. Pat. No. 5,190,747 to Sekiguchi et al.; and U.S. Pat. No. 4,051,234, Gieske, et al., each of which patents are herein incorporated by reference in their entirety.

In certain embodiments, the compositions of the claimed invention comprise amphoteric and/or zwitterionic surfactants at from about 0.05% to about 2%, optionally, from about 0.2 to about 0.8%, by weight of the total composition.

In certain embodiments, the curable composition of the present invention further comprise components for treatment of, or prophylaxis against formation of, wounds and/or skin abnormalities, e.g. with emollients or an active constituent e.g. salicylic acid, alpha hydroxy acids, and/or retinoids for treating or preventing formation of psoriasis, eczema, callous skin, corns, insect bites, acne or blisters. The present invention may also contain active agents such as bacteriostatic or bactericide compounds, e.g., polymyxin, bacitracin, neomycin, iodine, iodopovidone complexes, chloramine, chlorohexidine, silver salts, zinc or salts thereof, tissue-healing enhancing agents, e.g. RGD tripeptides and the like, enzymes for cleansing of wounds, e.g. pepsin, trypsin and the like, pain relieving agents, or agents having a cooling effect (e.g., menthol) is also considered an aspect of the invention. Mixtures of any of the agents may also be used.

### Formulation Preparation:

In certain embodiments, the absorbent material is UV-curable and formed from the combination of at least two different pre-mixtures—a first and second pre-mixtures A and B. The formulation, including its various pre-mixtures, is prepared at room temperature (25° C.). The first pre-mixture A, comprising acrylate monomer and acrylate oligomer compound, is responsible for providing the desired mechanical properties of the material. The second pre-mixture B, comprising the superabsorbent polymer and surfactant, behaves as a hydrogel which has fluid absorption capacity. Optionally, surfactants help facilitates cohesion between the hydrophobic and hydrophilic parts of the material. After UV curing, the formed, dried absorbent material can absorb up to 40% of water.

### EXAMPLES

Any compositions of the present invention as described in following examples illustrate specific embodiments of compositions of the present invention but are not intended to be limiting thereof. Other modifications can be undertaken by the skilled artisan without departing from the spirit and scope of this invention.

### Example 1

A composition used in forming the inventive film is described in Table 1.

TABLE 1
Composition for forming an embodiment of the absorbent film of the present invention.

| | | | Commercial | | |
|---|---|---|---|---|---|
| | Type | Chemical name | name | % w/w | |
| Mixture | Oligomers | Aliphatic urethane diacrylate | Photomer 6643/ | 60 | 70 |
| A | | | GU3001Z | | |
| | | Aromatic urethane hexaacrylate | Photomer 6720/ | 5 | |
| | | | GU6600Y | | |
| | Monomers | 2-[[(butylamino)carbonyl]oxy]ethyl | Photomer 4184 | 20 | |
| | | acrylate | | | |
| | | Tripropyleneglycol diacrylate | Photomer 4061/ | 10 | |
| | | (TPGDA) | GM62A00 | | |
| | Photoinitiator | Ethyl (2,4,6-Trimethylbenzoyl)- | Omnirad TPO- | 5 | |
| | | phenylphosphinate | L | | |
| Mixture | Solvent | Distilled water | water | 95 | 30 |
| B | Absorbent | Sodium polyacrylate | SAP | 4 | |
| | Surfactant | PEO-PPO-PEO | Pluronic F-127 | 1 | |
| | | | (Poloxamer | | |
| | | | 407) | | |

The composition of Table 1 was prepared by, firstly, forming first pre-mixture A by adding together the oligomers, monomers and UV-free radical photo initiators and stirring until visibly (i.e., by observation with the naked eye with 20/20 vision) uniform and homogeneous (i.e., no phase separation). This step itself enables the creation of a mechanical resistance of the film after UV curing. Second pre-mixture B was prepared by dissolving the surfactant in water. The superabsorbent polymer was dispersed in the second pre-mixture B and stirring until visibly (i.e., by observation with the naked eye of 20/20 vision) uniform and homogeneous (i.e., no phase separation), producing a gel. Both pre-mixture A and B were combined and mixed using vigorous agitation to reduce the size of the agglomerated gel dispersed in pre-mixture A. Without being limited by theory, it is believed that any gel particles that are too large (e.g., greater than 500 (or about 500) microns) might prevent the miscibility and/or dispersibility of pre-mixtures A and B, potentially interfering with the unique material properties of the film of the present invention.

The resultant composition was UV cured (i.e., cured using UV radiation or light), obtaining a single layer material with fluid absorption capacity, elasticity and mechanically structured. (Optionally, additional layers may also be added, as desired.)

### Example 2

The stress and deformation tests were performed on the inventive cured film formed from the composition of Table 1 using dynamometer equipment (EMIC model no. DL-500) under ambient temperature conditions (about 21°−25° C.). Samples of each material were cut in dimensions of 25.4 mm×120 mm and put on the equipment claws with a gap of 100 mm between the claws. The test cell load used in equipment was 20 kgf. The test was performed at speed of 300 mm/min with a force limit of 4.5 kgf and strain limit of 1000 mm. The equipment uses the following equations to determine the total stress and deformation.

$$\begin{matrix}σ = \frac{F}{A} & \begin{matrix}Stress \\ In Pa or N . {mm}^{2}\end{matrix} \\ e = \frac{Δ L}{{L}_{0}} & \begin{matrix}Strain \\ No units\end{matrix}\end{matrix}$$

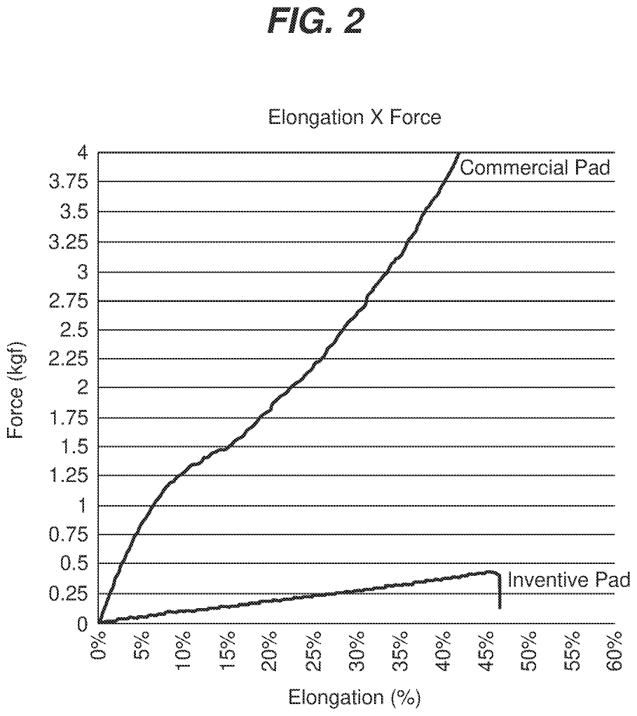

The inventive cured film obtained from the composition of Table 1 exhibits unique mechanical properties which are illustrated in FIG. 2 which illustrates the ratio between force and elongation (deformation). The graph at FIG. 2 compares the properties of a commercially available product (Delstar®) containing as one of its layers an absorbent layer which is a polyester single non-woven absorbent layer typically used in bandage products (the “Commercial Pad”) and the inventive, cured film obtained from the composition of Table 1, (the “Inventive Pad”).

The graph at FIG. 2 shows that the Commercial Pad requires much more force in order to elongate (or deform), which is a problem in some product applications (e.g., wound dressing—due the stress generated near the wound by the resistance of material to deform). In contrast, the Inventive Pad formed from the composition of Table 1 achieved higher than 30% elongation (which is the average elongation or deformation for human skin) with significant lower force. A potential benefit is that the lower force required to elongate an absorbent film can help avoid skin stress damage or even additional injuries to the wounded tissue.

### Example 3

The absorption capacity of the inventive film formed from the composition of Table 1 was evaluated by the following method.

In a 250 mL beaker, it was added 100 mL of distilled water. Samples of the absorbent materials (each of commercially available ConvaTec Hydrocolloid and Coloplast Hydrocolloid pads and the Inventive Pad—see below) were cut in the dimensions of 50×50 mm and the weight of every single one of them were taken, registering this data as their dry mass. The samples were submerged inside the beaker with distilled water (about 21°−25° C.) for 30 minutes. After it, samples were removed and patted dry with a soft paper. The dried samples were weighted to determine their final mass. The absorption capacity is obtained by the following formula:

Water absorption capacity=((Wet mass−Dry mass)/Dry mass)×100

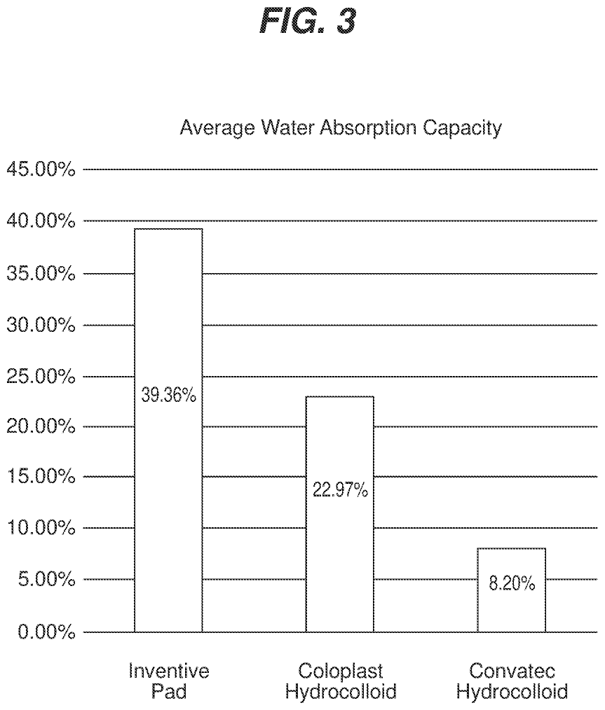

The results for the absorption capacity are showed in the FIG. 3. It compares the absorption capacity of the inventive cured, dried single layer material formed from the composition of Table 1 (called Inventive Pad) with the absorption capacity of some known commercially available products, each, containing as one of their respective product layers a single absorbent hydrocolloid layer sold under DuoDERM by ConvaTec Group plc (ConvaTec Hydrocolloid) and under Comfeel Plus Hydrocolloid by Coloplast A/S (Coloplast Hydrocolloid). The graph demonstrates that over the same time, the Inventive Pad provided significantly greater absorption as compared with ConvaTec and Coloplast commercial products (39.36% average water absorption capacity for Inventive Pad versus 22.97% average water absorption capacity for Coloplast Hydrocolloid and 8.2% average water absorption capacity for Convatec Hydrocolloid).

What is claimed is:

1. A composition for preparing radiation curable substrates, the composition before curing comprising:
(vi) An acrylate monomer having the formula: 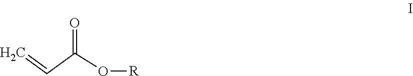
wherein R is a hydrogen; an inorganic charged ion; a linear, branched or aromatic alkyl group having a carbon chain length of less than 30 carbons, the alkyl group comprising one or more single, double or triple carbon bond(s); an acrylate group selected from acrylates (mono), di-acrylates, tri-acrylates, tetra-acrylate, pent-acrylate and hex-acrylates;
(vii) A acrylate oligomer having the formula: 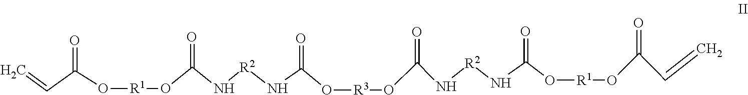
wherein R¹, R² or R³ are, independently, aromatic or aliphatic organic groups having a carbon chain length of less than 50 carbons, the alkyl group comprising one or more single, double or triple carbon bond on its structure; an acrylate group \selected from acrylates (mono), di-acrylates, tri-acrylates, pent-acrylates, hex-acrylates; a C₁-C₃ organic functional group selected from acids, alcohols, ethers, esters, ketones, thiols, amines, aldehydes and amides; a hydrogen or an inorganic charged ion;
(viii) one or more absorbent polymers;
(ix) a photo initiator; and
(x) a solvent.

2. The composition of claim 1 wherein the acylate monomer is selected from the group consisting of acrylates (mono); di-acrylates; tri-acrylates; tetra-acrylates; hex-acrylates;
variations of these compounds and mixtures thereof.

3. The composition of claim 2 wherein the acrylate monomer comprises one or more of acrylates (mono) and di-acrylates.

4. The composition of claim 3 wherein the acrylate monomer is selected from the group consisting of 2-[[(butylamino)carbonyl]oxy]ethyl acrylate, di-acrylates such as tripropyleneglycol diacrylate (TPGDA) and mixtures thereof.

5. The composition of claim 1 wherein the acrylate oligomer is selected from the group consisting of aliphatic urethane diacrylate, aromatic urethane hexaacrylate and mixtures thereof.

6. The composition of claim 1 wherein the photo initiator is selected from the group consisting of type I photo initiators, type II photo initiators, and mixtures thereof.

7. The composition of claim 6 wherein the type I photo initiator is selected from the group consisting of benzyl ketals, a-hydroxyalkyl phenones, a-amino alkyl phenones, and acylphospine oxides—such as Omnirad TPO-L (ethyl (2,4,6-trimethylbenzoyl)-phenylphosphinate, supplied by IGM) and/or 2-hydroxy-2-methyl-1-phenylpropan-1-one and mixtures thereof.

8. The composition of claim 6 wherein the photo initiator type 2 is selected from the group consisting of benzophenone, thioxanthone, isopropyl thioxanthone and camphorquinone and mixtures thereof.

9. The composition of claim 6 further comprising co-initiator selected from amines, polymeric amine synergists, thiols and mixtures thereof.

10. The composition of claim 1 wherein the solvent is selected from organic solvents, inorganic solvents and mixtures thereof.

11. The composition of claim 1 wherein the solvent comprises water.
